(19) United States
(12) Patent Application Publication
(10) Pub. No.: US 2009/0273871 A1
(43) Pub. Date: Nov. 5, 2009

(54) Virtual Closed Loop Power Distribution System and Method

(75) Inventor: Raymond P. O'Leary, Evanston, IL (US)

Correspondence Address: MARSHALL, GERSTEIN & BORUN LLP (S & C), 233 S. WACKER DRIVE, SUITE 6300, SEARS TOWER, CHICAGO, IL, 60606-6357, US

(73) Assignee: S & C Electric Co., Chicago, IL (US)

(21) Appl. No.: 12/159,134

(22) PCT Filed: Dec. 4, 2006
(86) PCT No.: PCT/US06/46319

§ 371 Date: Oct. 21, 2008

Related U.S. Application Data
(60) Provisional application No. 60/753,740, filed on Dec. 27, 2005.

(51) Int. Cl. H02H 7/26

(52) U.S. Cl. 361/67

(57) ABSTRACT

A virtual closed loop power distribution system couples a parallel source to a feeder upon an initial indication of a fault existing on a distribution feeder If the fault is persistent, a fault protection system including fault protection devices segmenting the distribution feeder operates to isolate the fault segment of the distribution feeder from each of the coupled sources. The coupled sources provide substantially uninterrupted service to the non-faulted segments of the distribution feeder until a circuit reconfiguration and return-to-normal function operates to restore the system upon repair of the fault.

### TECHNICAL FIELD

This patent relates to the control of an electric power distribution system, and more specifically to a system and method of fault mitigation in an electric power distribution system utilizing a virtual closed loop arrangement.

### BACKGROUND

Power distribution systems typically include distribution feeders (ranging from approximately 4 KV to 69 KV) originating in power distribution substations and leading to the source of supply for end customers of the electrical supply utility or agency. Typically the feeders have an open loop arrangement. That is, a single source feeds the feeder that extends from the source to service loads. The feeder may be joined to another feeder and another source, but typically such joining is accomplished by a normally open switching device. Coupling to the second source allows the second source to service loads on the feeder in the event a fault causes isolation of the feeder or a portion of the feeder from its normal source. That is, upon detecting a fault on the feeder, a fault protection device operates to isolate the fault from its normal source. If a de-energized portion of the feeder can be isolated from the faulted portion, the normally open switch can be closed to supply the loads on that portion of the feeder from the alternate source. A return to normal circuit recovery strategy, such as provided by the IntelliTEAM® product available from S&C Electric Company, Chicago, Ill., may be employed to restore the normal configuration of the circuit—the feeder sourced to its normal source and the normally open switch reopened to separate the alternate source from feeder—upon repair of the fault.

While the above-described circuit configuration allows early restoration of service to loads on non-faulted portions of the feeder, after the fault is isolated but before it is fully repaired, there is typically a delay associated with detecting the fault, isolating the fault, determining a non-faulted portion of the feeder may be serviced by the alternate source, ensuring the non-faulted portion of the feeder is isolated from the fault and closing the normally open switch to service the feeder from the alternate source.

An alternative circuit configuration, referred to as a closed loop configuration, can reduce or potentially eliminate the service interruption by ensuring that the non-faulted portion of the feeder is always serviced. In a closed loop configuration, the feeder is serviced by two or more sources configured to supply various ends of the straight or branched feeder. Closed loop configurations are also referred to as parallel source arrangements with the sources referred to as being paralleled. Closed loop configurations, however, require substantial, complex and expensive communication and control to ensure source phase and voltage synchronization to prevent large overcurrents at the serviced loads. Additionally, directional time-overcurrent protection devices may be required for load protection on the feeder. These protection devices are required to be coordinated for faults fed from any source.

### BRIEF DESCRIPTION OF THE DRAWINGS

FIGS. 1a-1e are a schematic diagrams of a power distribution feeder illustrating operation for substantially continuous service in the presence of a fault on a segment of the distribution feeder;

FIGS. 2a-2f are schematic diagrams of a power distribution feeder illustrating operation for substantially continuous service in the presence of a fault on a segment of the distribution feeder;

FIG. 3 is a flowchart illustrating a method providing substantially continuous service in the presence of a fault on a segment of a distribution feeder.

### DETAILED DESCRIPTION

A virtual closed loop power distribution system couples a parallel source to a feeder upon an initial indication of a fault existing on a distribution feeder. If the fault is persistent, a fault protection system including fault protection devices segmenting the distribution feeder operates to isolate the fault segment of the distribution feeder from each of the coupled sources. The coupled sources provide substantially uninterrupted service to the non-faulted segments of the distribution feeder until a circuit reconfiguration and return-to-normal function operates to restore the system upon repair of the fault.

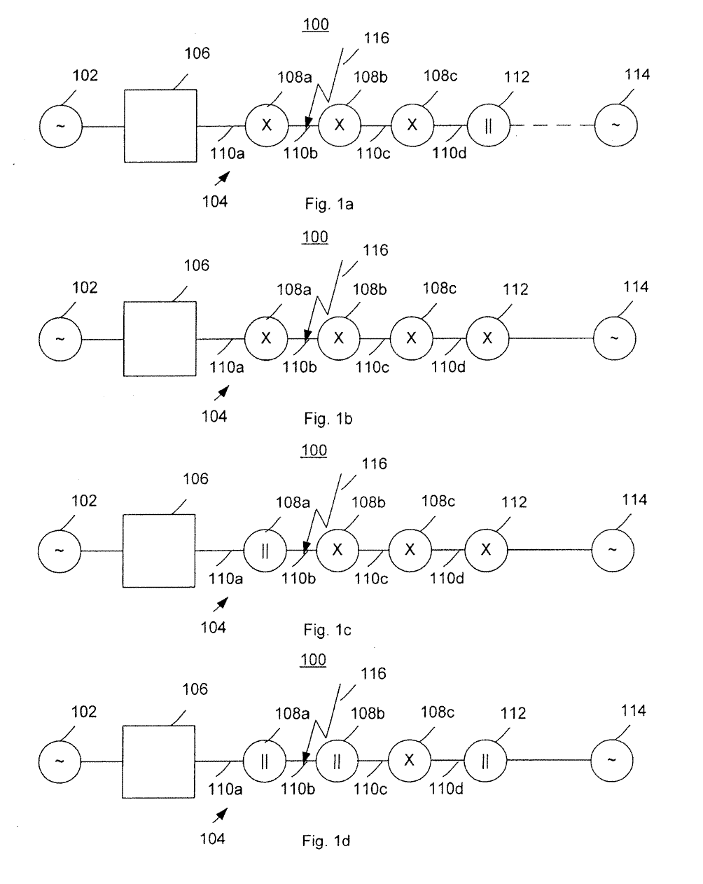

Referring to FIGS. 1a-1e, a power distribution system 100 includes a source 102 coupled to a distribution feeder 104 via a source protection device 106, for example a circuit breaker. A plurality of fault protection devices 108a, 108b and 108c, for example vacuum fault interrupters or other suitable fault protection devices, segment the distribution feeder 104 into segments 110, 110b, 110c and 110d. A normally open switch 112 couples the distribution feeder 102 to a parallel source 114. In normal operation, the source 102 provides electric power via the distribution feeder 104 to loads (not depicted) coupled to the segments 110a-110d. The normally open switch 112 remains open in normal operation isolating the parallel source 114 from the distribution feeder 104. It should be understood that while a normally open switch 112 is illustrated, in other implementations this may be a fault protection device or other circuit switching device.

FIG. 1a illustrates a fault 116 occurring on the segment 110b between the fault protection devices 108a and 108b. Upon detection of an anomaly on the distribution feeder 104 as a result of the fault 116, for example a voltage interruption or loss of voltage, the normally open switch 112 is caused to close. There may be provided a slight delay following the initial indication of a fault to determine whether the fault is transient, but if the fault is persistent after the delay period the normally open switch 112 is caused to close (FIG. 1b). From a timing perspective, the normally open switch 112 closes within a time between 0.025 seconds to about 50 milliseconds (ms) seconds after detecting the fault 116. As configured in FIG. 1b, the distribution feeder is feed in parallel by the primary source 102 and the parallel source 114. Both sources are also feeding the fault 116; however, this condition will only exist for a brief period of time.

As shown in FIG. 1c, the fault protection device 108b, upon detecting the fault, operates in accordance with its established fault operating parameters, for example a time overcurrent curve, to open to isolate the source 102 from the fault. The fault protection device 108b will typically operate within about 100 ms to about 200 ms, and for example, the fault protection device 108b operates to clear the fault at about 150 ms isolating the fault from the source 102. However, the fault 116 is still being fed by the alternate now parallel connected source 114.

The fault protection device 108c will detect and operate to clear the fault 116 in accordance with its fault operating parameters, e.g., a time overcurrent curve. It is worth noting at this point that the fault protection devices 108a-108d may be configurable to have multiple fault operating parameters and characteristics, for example operating characteristics that are directional, such that each operates appropriately in response to a fault sourced from either end of the feeder 104.

Thus, as illustrated in FIG. 1d, the fault detection device 108b operates to clear the fault 116 as a result of the alternate source 114 being paralleled to the feeder 102. The fault protection device 108b may operate within about 100 ms to about 300 ms, and for example the fault protection device 108b will operate within about 250 ms to clear the fault. The fault 116 is thus isolated from both the source 102 and the source 114, while at the same time all segments of the feeder 104 with the exception of the faulted segment 104b experienced substantially uninterrupted service.

As illustrated in FIG. 1e, circuit testing procedures may be undertaken to determine whether the fault is transient or persistent. A suitable reclosing strategy will determine whether the fault remains after a given period of time, and if it does remain, the fault protection devices 108a and 108b may suitably lock out to isolate the fault 116 until it can be repaired. After repair of the fault 116 is effected, a circuit restoration strategy returns the feeder 104 to its normal operating state. That is, the feeder 104 is supplied by the source 102 with the source 114 being decoupled from the feeder 104 by the normally open switch 112 being placed in its open state.

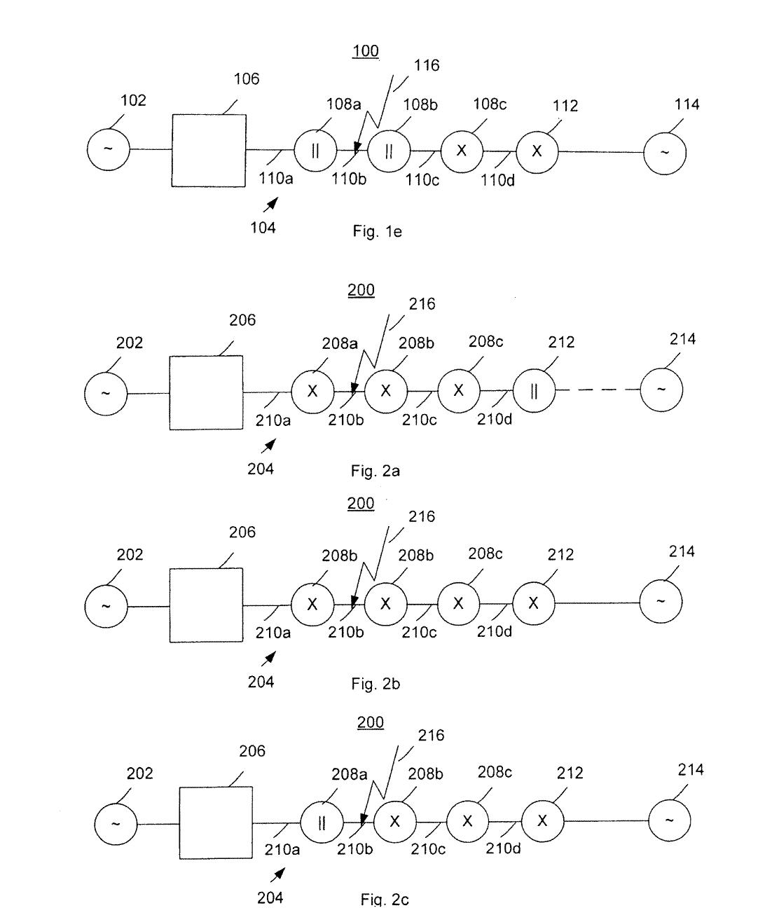

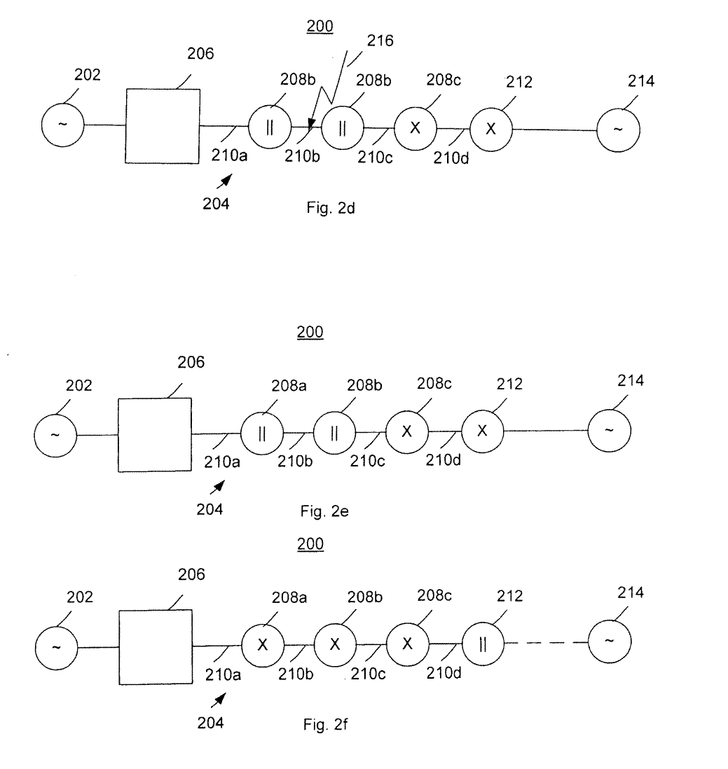

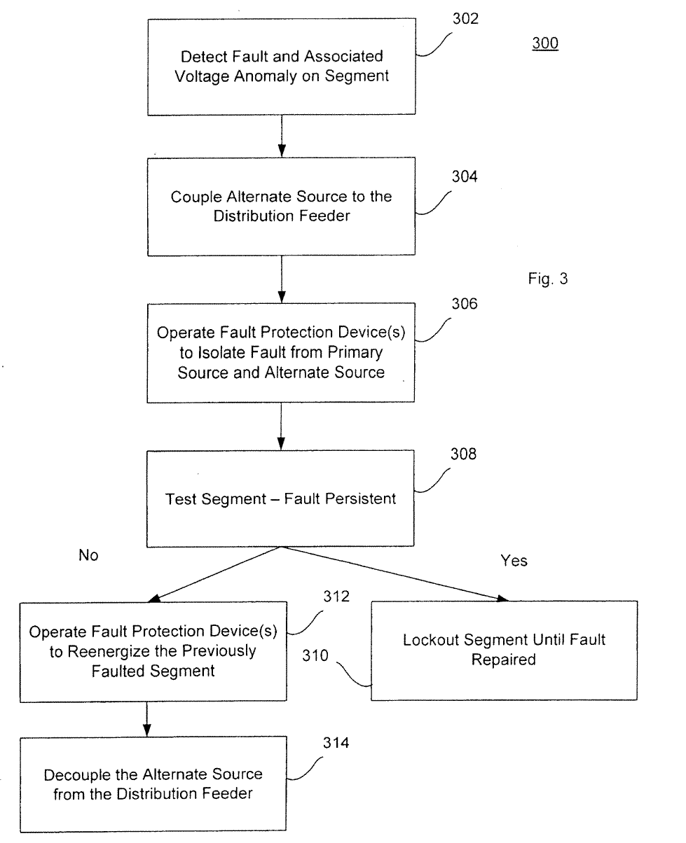

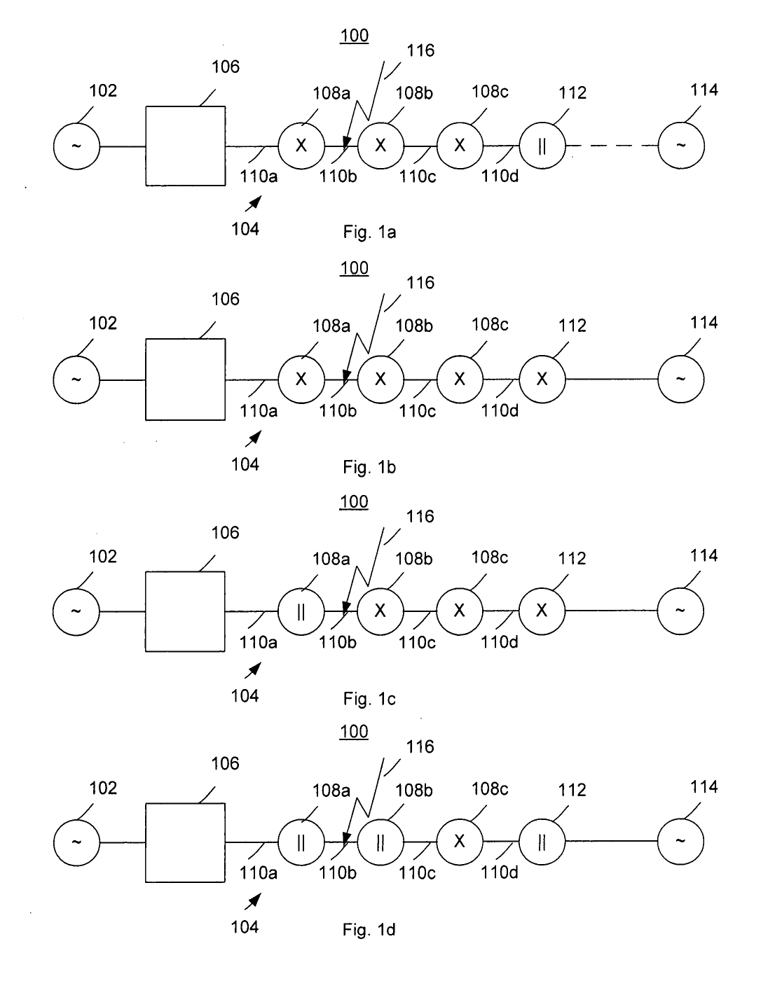

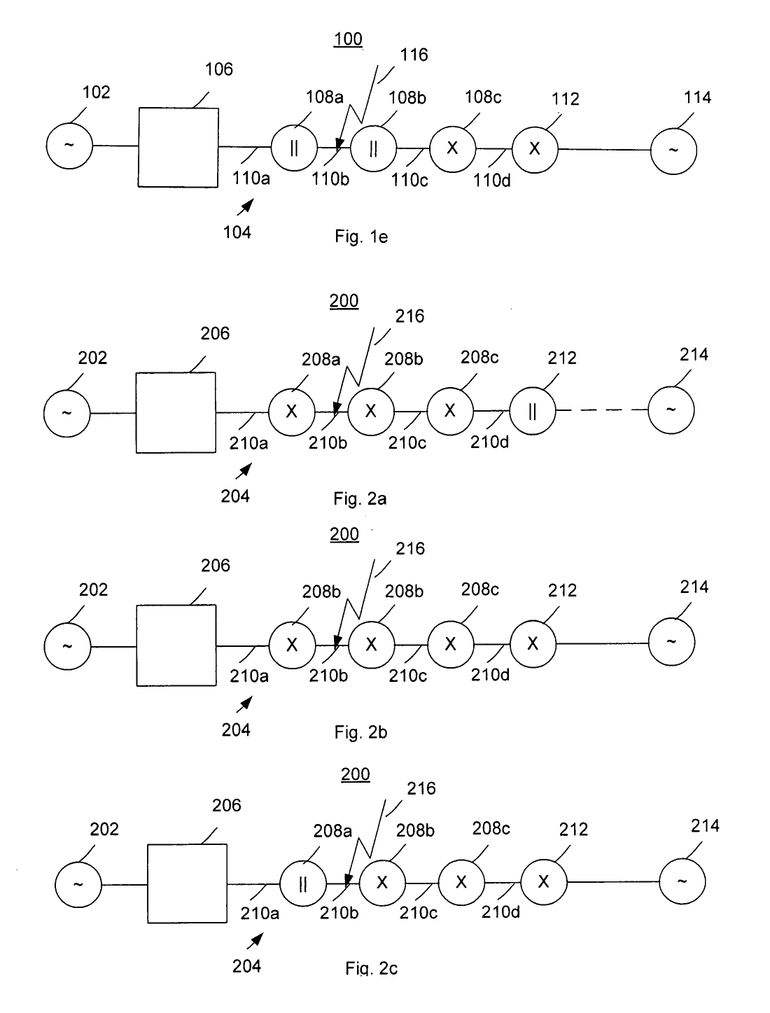

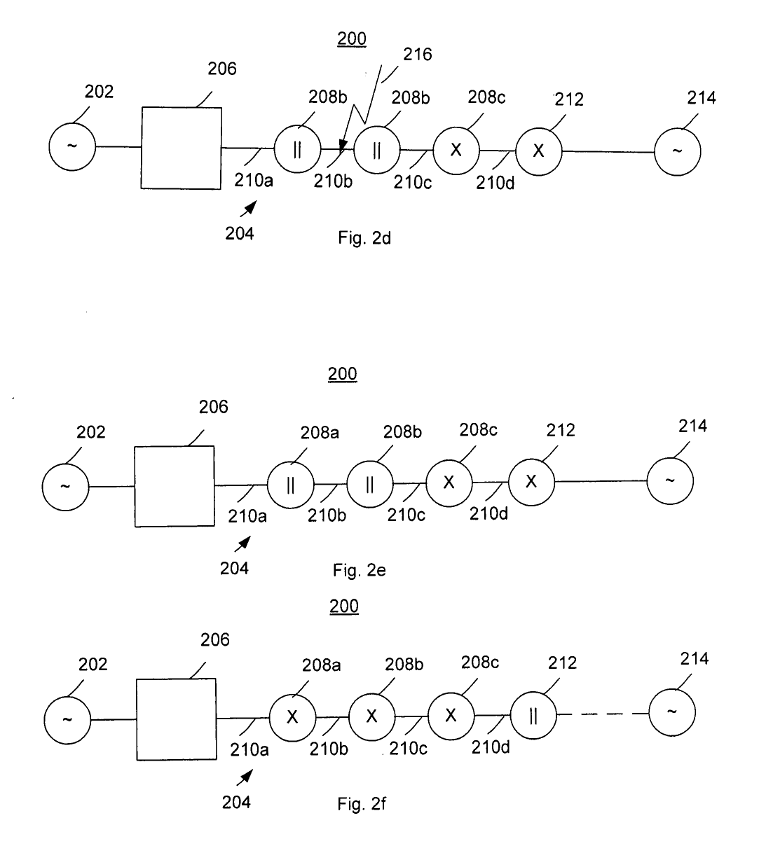

FIGS. 2a-2f illustrate a fault protection sequence that also provides a temporary parallel source or closed loop arrangement followed by fault isolation and circuit reconfiguration. In FIGS. 2a-2f, the power distribution system 200 is substantially as illustrated in FIGS. 1a-1e, and like references numeral beginning with a 200 designation are used to identify like elements.

FIG. 2a illustrates a fault 216 occurring on the segment 210b between the fault protection devices 208a and 208b. Similar to the methods described above in connection with the embodiment of FIGS. 1a-1e, as shown in FIGS. 2a-2d, the parallel source 214 is coupled to supply the feeder 204, and the fault protection devices 208a and 208b operate to isolate the fault from the source 202 and the source 214, respectively.

At FIG. 2e, the fault protection device 208a is operable to test the feeder 204 to determine the persistence of the fault 214. Such testing may occur after a delay period, for example of about 500 ms to about 1000 ms, and for example the fault protection device 208a may initiate a testing process at about 800 ms. If the fault 216 is transient and the segment 210b tests as non-faulted, the fault protection device 208a operates to couple the segment 210b to the source 202. As a result, the entire feeder 204 is energized by the parallel coupled sources 202 and 214. However, this condition is temporary, and the normally open switch 212 reopens, after receiving communications that 208a & 208b have closed, to decouple the source 214 from the feeder 204, FIG. 2f.

Because in either of the examples illustrated, the sources 202 and 214 are paralleled, i.e., both coupled to the feeder 204 for only a relatively short period of time, typically less than several seconds, moderate mismatch of voltage and phase is tolerable. Thus, unlike typical closed loop systems that require complex and expensive control and communication capability to match the sources, neither the distribution system 100 nor the distribution system 200 require such communication and control capability. In the examples illustrated in FIGS. 1a-1e and 2a-2f, the fault is typically isolated in less than 500 ms, segment testing begins in less than 1000 ms, and in the case of a transient fault, full, normal service is restored in less than 1200 ms. Furthermore, and advantageously, service is maintained to all of the loads coupled to the feeder 204 except for those coupled to the actually faulted segment.

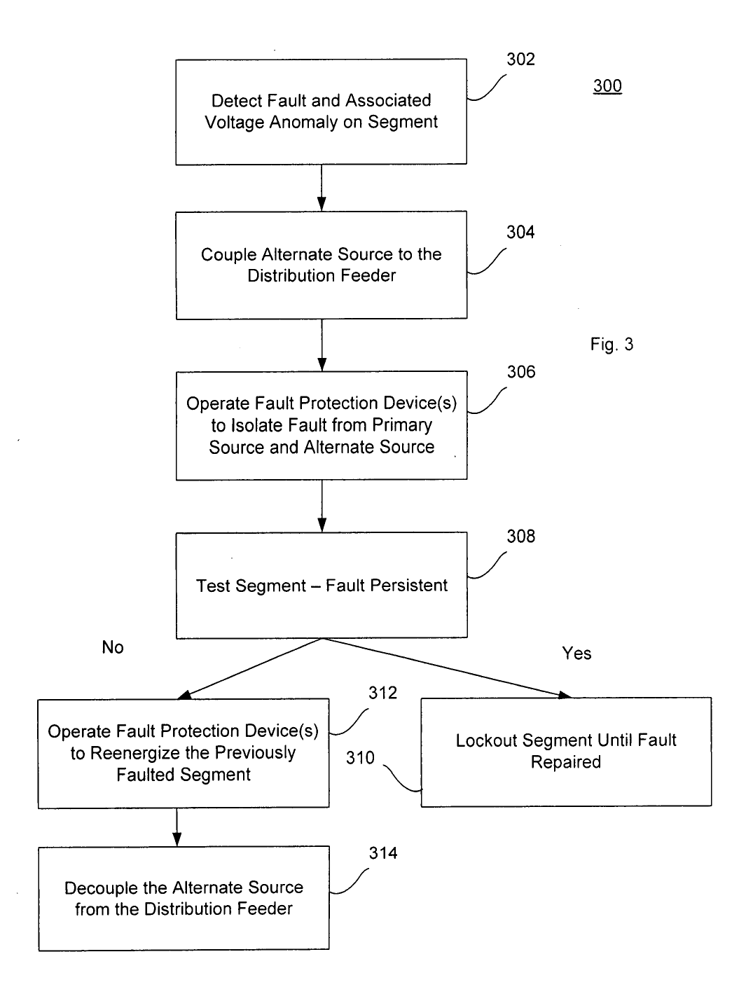

The flowchart of FIG. 3 illustrates a method 300 of servicing a distribution feeder with substantially uninterrupted service and fault isolation. The method 300 begins at block 302 with the detection of voltage anomaly consistent with a fault in a segment of the distribution feeder. For example, a loss of voltage may be detected. Responsive to detecting the voltage anomaly, at block 304 an alternate source is coupled to the distribution feeder. In this arrangement, the alternate source is paralleled with the primary source for the distribution feeder. At block 306 fault protection devices operate to isolate the fault from each of the primary source and the alternate source. Following fault isolation, at block 308, segment testing determines whether the fault is persistent or transient. If the fault is persistent, the fault protection devices lockout the segment until repairs can be made, block 310. If the fault is transient, the primary source-side fault protection device and the alternate source-side fault protection devices operate to reenergize the previously faulted segment, block 312. Finally, the normally open switch opens to isolate the fault from the parallel source, block 314.

While the invention is described in terms of several preferred embodiments of circuit or fault interrupting devices, it will be appreciated that the invention is not limited to circuit interrupting and disconnect devices. The inventive concepts may be employed in connection with any number of devices including circuit breakers, reclosers, and the like.

While the present disclosure is susceptible to various modifications and alternative forms, certain embodiments are shown by way of example in the drawings and the herein described embodiments. It will be understood, however, that this disclosure is not intended to limit the invention to the particular forms described, but to the contrary, the invention is intended to cover all modifications, alternatives, and equivalents defined by the appended claims.

It should also be understood that, unless a term is expressly defined in this patent using the sentence “As used herein, the term ‘______ ’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Unless a claim element is defined by reciting the word “means” and a function without the recital of any structure, it is not intended that the scope of any claim element be interpreted based on the application of 35 U.S.C. §112, sixth paragraph.

I claim:

1. A fault protection system, comprising:
a source coupled to a distribution feeder;
an alternate source coupled by a normally open device to the distribution feeder;
a fault protection device segmenting the distribution feeder; wherein
upon detection of a fault and prior to operation of the fault protection device to isolate the source from the fault, the normally open device is operable to close to couple the alternate source to the distribution feeder.

2. The fault protection system of claim 1, wherein the fault protection device comprises a plurality of fault protection devices segmenting the distribution feeder into a plurality of segments, and a non-faulted segment being isolated from the source by at least one of the plurality of fault protection devices and being coupled to the alternate source by the normally open device being closed.

3. The fault protection system of claim 2, a first fault protection device of the plurality of the fault protection devices isolating the fault from the source and a second of the plurality of fault protection devices isolating the fault from the alternate source.

4. The fault protection system of claim 3, wherein on a segment of the distribution feeder affected by the fault being isolated from either the source or the alternate source.

5. The fault protection system of claim 1, all segments of the distribution feeder except the segment affected by the fault being serviced by one of the source and the alternate source.

6. The fault protection system of claim 1, all segments of the distribution feeder except the segment affected by the fault being serviced by one of the source and the alternate source without any substantial interruption in service.

7. A method of controlling a power distribution system comprising a source coupled to a distribution feeder, an alternate source coupled to the distribution feeder by a normally open device and a fault protection device segmenting the distribution feeder into segments, the method comprising:
detecting a fault on a segment of the distribution feeder;
closing the normally open device to couple the alternate source to the distribution feeder;
operating the fault protection device to isolate the fault from the source.

8. The method of claim 7, wherein the fault protection device comprises a plurality of fault protection devices, the method comprising:
operating a first of the plurality of fault protection devices to isolate the fault from the source and operating a second of the plurality of fault protection devices to isolate the fault from the alternate source.

9. The method of claim 8, comprising operating the first fault protection device after closing the normally open device.

10. The method of claim 8, comprising operating the second fault protection device after closing the normally open device.

11. The method of claim 7, comprising isolating a segment of the distribution feeder affected by the fault from each of the source or the alternate source.

12. The method of claim 7, comprising servicing all segments of the distribution feeder except the segment affected by the fault from either of the source and the alternate source.

13. The method of claim 7, comprising maintaining substantially uninterrupted service to all segments of the distribution feeder except the segment affected by the fault by one of the source and the alternate source.
